(19) United States
(12) Patent Application Publication
(10) Pub. No.: US 2007/0131284 A1
(43) Pub. Date: Jun. 14, 2007

(54) Montgomery soft stroke one way valve

(76) Inventor: W.C. Gray Montgomery, Vidalia, LA (US)

Correspondence Address: W.C. Gray Montgomery, 1627 Camellia St., Vidalia, LA, 71373, US

(21) Appl. No.: 11/301,306

(22) Filed: Dec. 13, 2005

(51) Int. Cl. F16K 15/03

(52) U.S. Cl. 137/512.1

(57) ABSTRACT

The Montgomery Soft Stroke One Way Valve is designed to open and close more than four million times a year, as floats in the ocean go up and down with swells to compress water to make electricity. The valve is preferably round with vanes that open and close. The vanes are spaced around the valve body much like the segments of a grapefruit cut in half. Each segment is made with 60% surface on one side and 40% surface on the other side of a sealed bearing pivot rod. The 60% side of the vane will open with the flow of water and the 40% side will open against the flow, that will lessen the striking force of the vane. The striking surface of each vane and body will be coated with durable material to reduce wear.

The one way valve 219 is specially designed with six to eight or more vanes, 220.

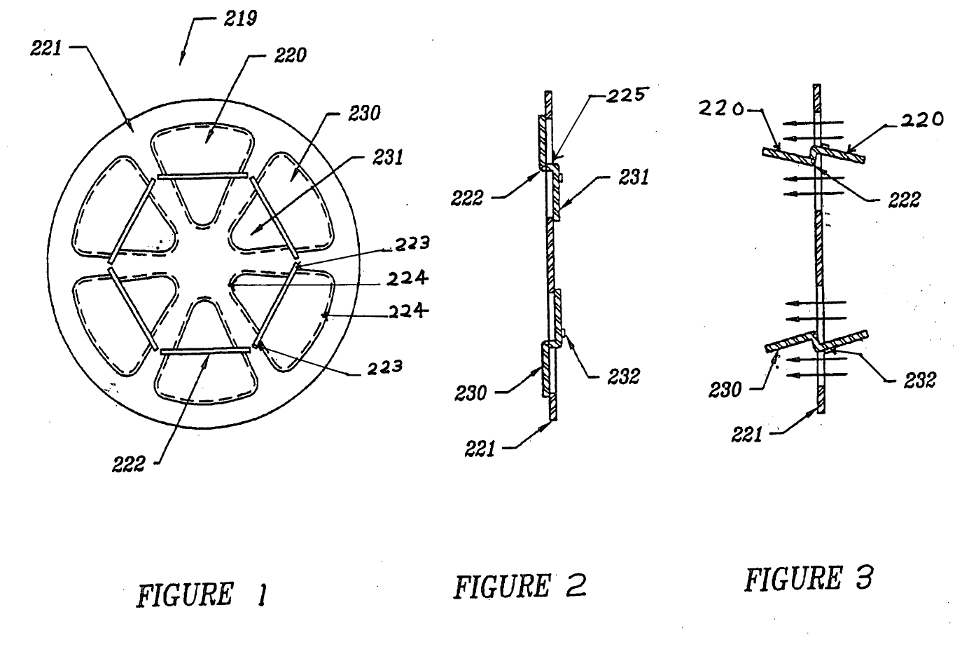

The one way valve 219 in FIG. 1, is drawn as if you were inside of the pipe, looking directly at the one way valve, 219. One way valve 219 can be made with any diameter, that works best with the project. FIG. 2 is a side view of one way valve 219, that is closed because the pressure of the fluid is trying to go from left to right, putting more pressure on the 60% side 230 of vane 220 that's over coming the opposing pressure on the 40% side 231 of vane 220, thus keeping vane 220 closed. FIG. 3 is a side view of one way valve 219 that is open, because the pressure of the fluid is going from right to left, putting more pressure on the 60% side 230 of vane 220 that's over coming the opposing pressure on the 40% side 231 of vane 220, thus keeping vane 220 open. The vanes 220 are made of stainless steel or other durable material. The body of the one way valve 221, is round and is attached permantly inside the pipe. The vanes 220 are placed around the body 221 of the one way valve 219, simular to the segments of a grapefruit cut in half. The vanes 220 are built oblong in shape and are mounted to the body 221 of the one way valve 219, by a rod 222, that is permanently attached to each vane 220. The rod 222 is attached to the body 221 by sealed bearings 223, one for each end of the rod 222. The bearings 223 let the vanes 220 open to about the 85° position. At the 85° position, the vane 220 is stopped by a stop point 232. This 85° stop position 232 is designed so that when the fluid changes in the other direction, it leaves a portion of the 60% side 230, of vane 220 exposed to catch the pressure. change, that will close vane 220. One area of the vane, 230 takes up 60% of the surface area, leaving 40% of surface area 231 for the other end of vane 220. The 40% side 231 of the vane 220, seats on one side of the one way valve body 221, and the 60% side 230 seats on the other side of the one way valve body 221. This is accomplished by making a 90° jog 225, back to a 90° jog in the vane 220. This is shown in FIG. 2. The pivot rod 222 is placed right in the middle of the 60% and 40% position. If you want the pressurized fluid to go through the one way valve 219, you place the body of the one way valve 219, with the 60% side of the vane 230 so it will open. The pressurized fluid will also exert force on the 40% side of the vane 231, but the 60% side 230 will overcome the pressure on the 40% side 231, and open the vane 220. The 40% side of the vane 231, was purposely made to go against the flow of fluid, to slow down the striking force of the vane 220, when it opens and hits the stop point 232. It will also slow down the striking force when the fluid changes direction, and the vane 220 seats shut. As shown in FIG. 2 the pressurized fluid is trying to go against the 60% side 230 of vane 220, so the pressure on the 60% side 230 of vane 220 overcomes the opposite pressure on the 40% side 231 of vane 220, this holds vane 220 shut on one way valve 219. In FIG. 3 the pressurized fluid is let through, by the action of the pressurized fluid pushing on the 60% side 230 of the vane, and overcoming the opposing force of the 40% side 231, thus letting one way valve 219 open. The striking surface of vane 220 and the place on body 221 where the vane 220 seats 224, and the 85% stop point 232 will be preferably coated with rubber, plastic or other similar material in order to facilitate a good seal when it closes, and reduce wear and tear when it opens, as the vanes 220 are estimated to open and close approximately four million times a year. To make the Montgomery Soft Stroke One Way Valve 219 go the other way, simply turn it around.

I claim:

1. I have invented a one way valve, called Montgomery Soft Stroke One Way Valve, that has multival vanes installed in the valve that are specially designed to open and close with gentle striking forces that will allow the vanes to open and close numerous times with out failure, which is what you must have to generate electricity from ocean swells, that will cause a float to go up and down, every several seconds, which in turn will cause the Montgomery Soft Stroke One Way Valve to open and close.
